(19) United States
(12) Patent Application Publication
(10) Pub. No.: US 2026/0152249 A1
(43) Pub. Date: Jun. 4, 2026

(54) Seat Device for a Tilting Vehicle

(71) Applicant: Bayerische Motoren Werke Aktiengesellschaft, Muenchen (DE)

(72) Inventors: Adrian GOLLING, Groebenzell (DE); Dieter STRASSER, Oberhausen (DE)

(21) Appl. No.: 18/717,232

(22) PCT Filed: Jan. 19, 2023
(86) PCT No.: PCT/EP2023/051162

§ 371 Date: Jun. 6, 2024

(30) Foreign Application Priority Data
Feb. 15, 2022 (DE) 10 2022 103 466.6

(51) Int. Cl. B60N 2/02; B60N 2/10; B60N 2/14; B60N 2/22

(52) U.S. Cl. CPC B62J 1/08

(57) ABSTRACT

A seat device for a tilting vehicle has a first seat bench region with a first seat surface and a first pan element; a second seat bench region with a second seat surface and a second pan element; a support unit to which the first seat bench region and to which the second seat bench region can be fixed; and an adjusting device by which the second seat bench region can be detached without tools by moving counter to a joining direction out of a first seat position, in which the distance between the first seat bench region and the second seat bench region is minimal and in which the second seat bench region is fixed so as to prevent movement transversely to the joining direction, and can be transferred into an adjusting position in which the second seat bench region is released for movement transversely to the joining direction and in which, by moving in the joining direction, the second seat bench region, which is moved transversely to the joining direction, can be positioned in a second seat position which is offset with respect to the first seat position and in which the distance between the first seat bench region and the second seat bench region is increased with respect to the first seat position and in which the second seat bench region is fixed so as to prevent movement transversely to the joining direction.

### BACKGROUND AND SUMMARY

The invention relates to a seat device for a tilting vehicle.

Various embodiments of seat devices are known from the prior art. Tilting vehicles are known in which, rather than seat bench supports being provided, the seat device is fixed directly to the vehicle frame. This means that an automatic adjustment of the seat device in the longitudinal direction is no longer possible. In order to adjust the seat device, the seat device has to be laboriously released at a garage, moved and re-fixed. This proves to be time-consuming and costly.

It is an object of an exemplary embodiment of the invention to propose a seat device for a tilting vehicle, in which a longitudinal adjustment of the seat device is made possible and the risk of incorrect operation by a user of the tilting vehicle is reduced.

This object is achieved by a seat device for a tilting vehicle, having at least one first seat bench region, which comprises a first seat surface, on which a rider can be positioned for guiding and operating the tilting vehicle, and which comprises at least one first pan element, having at least one second seat bench region, which comprises a second seat surface, on which a passenger, such as a pillion passenger, can be positioned, and which comprises at least one second pan element, having at least one support unit to which the first seat bench region and to which the second seat bench region can be fixed or are fixed, and having at least one adjustment mechanism, by which at least the second seat bench region can be released without a tool, by moving counter to a joining direction from a first seat position, in which the distance between the first seat bench region and second seat bench region is minimal and in which the second seat bench region is fixed against moving transversely with respect to the joining direction, and can be transferred into an adjustment position, in which the second seat bench region is released for moving transversely with respect to the joining direction and in which the second seat bench region, which is moved transversely with respect to the joining direction, can be positioned, by moving in the joining direction, in at least one second seat position which is offset with respect to the first seat position and in which the distance between the first seat bench region and second seat bench region is increased with respect to the first seat position and in which the second seat bench region is fixed against moving transversely with respect to the joining direction.

Owing to the fact that the seat device comprises a first seat bench region and a second seat bench region, wherein the second seat bench region is movable relative to the first seat bench region and can be positioned in a first and in a second seat position, the seat device can be changed with respect to its extent transversely with respect to the joining direction.

The joining direction can run transversely or obliquely with respect to the longitudinal axis of the tilting vehicle. Accordingly, the distance between the first seat bench region and second seat bench region should be understood as meaning transversely with respect to the joining direction. By this means, the seat device can be extended or shortened again parallel or obliquely with respect to the longitudinal axis of the tilting vehicle.

Owing to the fact that the second seat bench region can be released without a tool, by moving counter to the joining direction from the first seat position, and, in the adjustment position, can be transferred into at least one second seat position, the seat device can be adjusted by a user without a tool.

The joining direction can run parallel or obliquely with respect to a vertical axis of the tilting vehicle and can run in a direction away from the first seat surface or the second seat surface. By this means, the second seat bench region is arranged securely in the first seat position, or in the second seat position, and can be released from the first seat position, or from the second seat position, only by actively moving in the direction of the second seat surface, i.e. counter to the joining direction.

A tilting vehicle is understood as meaning bicycles, motorbikes or motor vehicles similar to motorbikes, such as motor scooters, in particular two-, three-or four-wheeled motor scooters, scooters, tiltable trikes, quad bikes or the like.

In a development of the seat device, it proves advantageous if the first seat bench region lies in contact at least in sections linearly or extensively on the support unit with the first pan element on the side facing away from the first seat surface, and/or if the second seat bench region, in the first seat position and in the second seat position, lies in contact at least in sections linearly or extensively on the support unit with the second pan element on the side facing away from the second seat surface and, in the adjustment position, is spaced apart with the second pan element from the support unit without contact.

If the first seat bench region or the second seat bench region lies in contact in each case with its pan element linearly or extensively on the support unit, forces of the first seat bench region or of the second seat bench region can easily be transmitted to the support unit. If, in the adjustment position, the second seat bench region is spaced apart from the support unit without contact, the second seat bench region can easily be transferred from the first seat position into the second seat position, and vice versa.

In order to facilitate arranging the second seat bench region in the first position and in the at least one second seat position, it proves advantageous if the adjustment mechanism comprises a guide unit by means of which the moving of the second seat bench region transversely with respect to the joining direction can be guided or is guided, wherein the guide unit comprises at least one continuous cutout, which extends transversely with respect to the joining direction, in the second pan element and at least one bolt-or pin-shaped guide means which extends in the joining direction and is fixed to the support unit and which comprises an, in particular complementary, cross section corresponding to the cutout.

Owing to the fact that the adjustment mechanism comprises a guide unit, transfer of the second seat bench region from the first seat position into the at least one second seat position can be guided. The cutout extends in such a case transversely with respect to the joining direction. Furthermore, the cutout can be extended parallel or obliquely with respect to the longitudinal direction of the tilting vehicle.

The guiding by the guide unit can be further improved if the guide unit comprises at least two cutouts and at least two guide means, in particular if the guide unit comprises at least four cutouts and four guide means corresponding thereto. In such a case, the risk of tilting is reduced and a precise arrangement of the second seat bench region over the respective seat bench positions is improved.

In addition, the provision of the guide unit makes it possible to improve the precise arrangement of the second seat bench region over the respective seat position, and therefore, after the second seat bench region is transferred into the first seat position or into the second seat position, it merely needs to be transferred in the transfer direction.

In a development of the last-mentioned embodiment, it proves advantageous if the at least one cutout forms a stop at a first end for the guide means in the first seat position of the second seat bench region and/or a stop at a second end for the guide means in the second seat position of the second seat bench region.

Owing to the fact that the at least one cutout of the guide unit forms a stop at a first end for the guide means in the first seat position of the second seat bench region and/or forms a stop at a second end for the guide means in the second seat position of the second seat bench region, a user of the tilting vehicle can easily transfer the second seat bench region from the one seat position into the other seat position and, by moving in the joining direction, can easily arrange the respective seat position. By formation of the at least one stop, a user of the tilting vehicle is not reliant on “trial and error”, but rather easily finds the respective predefined seat position.

In order to prevent moving of the second seat bench region in the different seat positions transversely with respect to the joining direction, it proves advantageous if the adjustment mechanism comprises at least one protrusion on the support unit or on the second pan element, and/or if the adjustment mechanism comprises at least two recesses, which are formed in a corresponding, in particular complementary, manner with respect to the protrusion, on the second pan element and on the support unit and of which one is arranged level with the first seat position and one is arranged level with the second seat position and in which the protrusion engages in the respective seat position and fixes the second seat bench region against moving transversely with respect to the joining direction.

It proves advantageous if the protrusion and the cutout are disengaged in the adjustment position.

In a development of the last-mentioned embodiment, it proves advantageous if the adjustment mechanism comprises at least two protrusions and if the adjustment mechanism comprises at least four cutouts. In such a case, two cutouts can be assigned to each protrusion, with a first cutout being assigned to the first seat position and the second cutout being assigned to the second seat position. Furthermore, it is also possible for more than two cutouts to be assigned to a protrusion and, in such a case, the seat bench region can be arranged in further seat positions.

In such a case, the further seat positions can be arranged between the first seat position and the second seat position.

In order to fix the second seat bench region of a support unit, it is provided, in a development of the seat device, that the adjustment mechanism comprises at least one fixing device by which the second seat bench region can be fixed to the support unit so as to be limited at least in its movement in or counter to the joining direction, and/or that the adjustment mechanism comprises at least one tensioning device by which the second seat bench region is pretensioned in the joining direction onto the support unit.

The fixing device can be designed technically as desired if it fixes the second seat bench region to the support unit so as to be limited in its movement in or counter to the joining direction. Fixing devices and tensioning devices can form a spring assembly by which the second seat bench region is pretensioned in the direction of the support unit. In such a case, when the second seat bench region is transferred from the respective seat position into the adjustment position, first of all the tensioning force of the tensioning device has to be overcome. In such a case, by means of the tensioning device, when the next seat position is reached, the tensioning device causes the second seat bench region to automatically move in the joining direction into the respective seat position. This makes it possible to ensure that the second seat bench region is always arranged in a seat position without manual action.

In interaction with the protrusion and the cutout, by this means, firstly, fixing against a movement transversely with respect to the joining direction and fixing counter to the joining direction can be ensured.

The fixing device can basically be designed as desired if it carries out the function of fixing the second seat bench region to the support unit so as to be limited at least in its movement in or counter to the joining direction.

In one embodiment of the seat device, it is provided that the fixing device reaches with a neck portion through the cutout and through an opening in the support unit, wherein the fixing device comprises a head portion with a cross section which is larger than the cross section of the cutout and which lies on the second pan element in the first seat position and the second seat position, and wherein at least one stop element can be fixed to the fixing device on the neck portion on the side facing away from the head portion and comprises a cross section which is enlarged with respect to the neck portion.

In such a case, the fixing device can be formed, for example, in the manner of a screw or bolt. The stop element which can be fixed to the neck portion can comprise a separate or separable component.

Furthermore, the stop element can be formed by the second pan element of the second seat bench region, for example if, on the side facing away from the head portion, the fixing device comprises an external threaded portion with which the fixing device can be screwed into the second pan element. Furthermore, the stop element can be realized by a bayonet closure which is formed between the second pan element and the fixing device.

In a development of the last-mentioned embodiments, it proves advantageous if the tensioning device is supported between the stop element and a side of the support unit facing away from the second pan element, in particular if the tensioning device is arranged on the fixing device in a manner circumferentially surrounding the neck portion of the fixing device.

In such a case, the fixing device is not fixed directly to the second pan element, but rather indirectly by the tensioning device, which is supported in relation to the stop element, which is fixed to the fixing device, and the second pan element.

If the tensioning device circumferentially surrounds the neck portion of the fixing device, the tensioning device is captively fixed.

Furthermore, embodiments of the seat device are contemplated, in which the support unit, the at least one fixing device and/or the at least one guide comprise components which are separable from one another, or form a common integral component.

If the support unit, the at least one fixing device and/or the at least one guide form components which are separable from one another, conventional seat devices can easily be retrofitted.

If the support unit, the at least one fixing device and/or the at least one guide form a common integral component, the seat device can be designed with a reduced number of components. Furthermore, an embodiment of the seat device can be provided in that the support unit comprises a separate component, and the fixing device and the guide form a common integral component.

Furthermore, embodiments of the seat device are contemplated, in which the support unit comprises an integral common component to which the first seat bench region and the second seat bench region can be fixed or are fixed, or in which the support unit comprises a first support element, to which the first seat bench region can be fixed or is fixed, and a second support element, to which the second seat bench region can be fixed or is fixed, wherein the first support element and second support element can be fixed or are fixed releasably or non-releasably to each other.

If the support unit forms an integral common component, the seat device can be designed with a reduced number of components. If the support unit comprises a first support element and a second support element, the second seat bench region can easily be exchanged, or a seat device, which exclusively comprises a support unit with a first support element, can be extended by a second support element and, by this means, by a second seat bench region.

In order to cushion a relative movement between the second seat bench region and the support unit, it proves advantageous if the seat device comprises at least one compressible buffer element which is arranged on the support unit, in particular on the second support element of the support unit, and which lies on the second pan element of the second seat bench region in the first seat position and the second seat position.

Further features, details and advantages of the invention emerge from the attached claims, from the graphical illustration and the description below of two preferred embodiments of the seat device.

### BRIEF DESCRIPTION OF THE DRAWINGS

FIG. 1 is a highly schematic side view of an exemplary embodiment of the seat device;

FIG. 2 is a perspective top view of a second pan element of the seat device according to FIG. 1;

FIG. 3 is a perspective top view of a second support element of the support unit according to FIG. 1;

FIG. 4 is a sectional view along the line AA according to FIG. 2;

FIG. 5 is a sectional view along the line BB according to FIG. 2;

FIG. 6 is a sectional view of a second exemplary embodiment of the seat device.

### DETAILED DESCRIPTION OF THE DRAWINGS

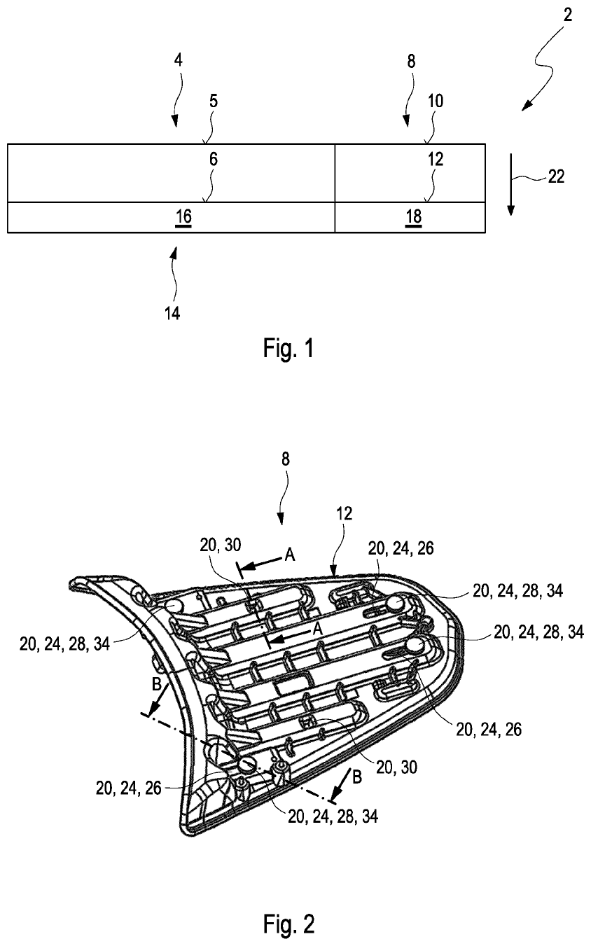

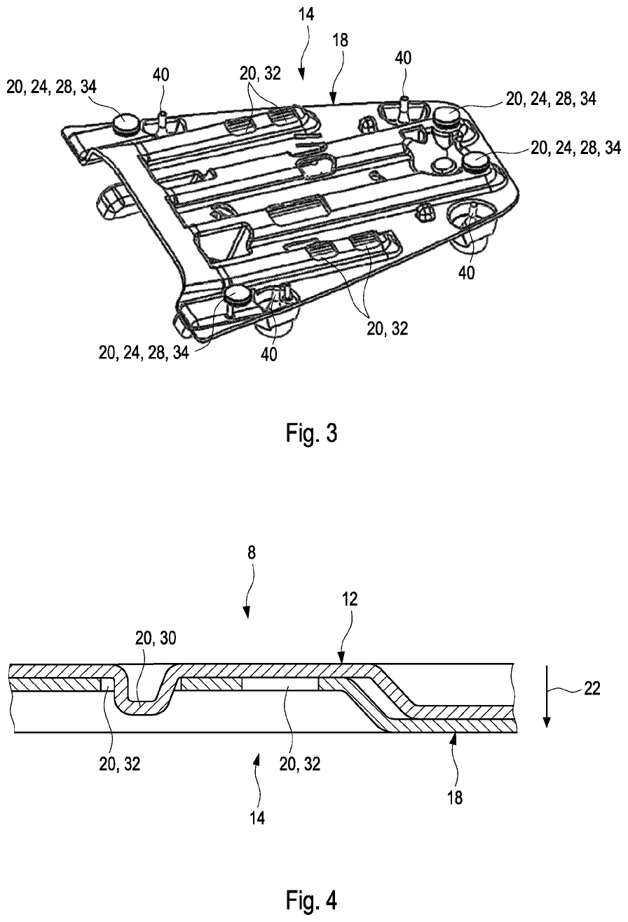

FIG. 1 shows a seat device, provided overall with the reference sign 2, for a tilting vehicle. The seat device 2 comprises a first seat bench region 4, which comprises a first seat surface 5, on which a rider can be positioned for guiding and operating the tilting vehicle, and which comprises at least one first pan element 6.

Furthermore, the seat device 2 comprises a second seat bench region 8, which comprises a second seat surface 10, on which a passenger, such as a pillion passenger, can be positioned, and which comprises at least one second pan element 12.

Furthermore, the seat device 2 comprises a support unit 14 to which the first seat bench region 4 and the second seat bench region 8 are fixed. In the exemplary embodiment illustrated in FIG. 1, the support unit 14 comprises a first support element 16 to which the first seat bench region 4 is fixed with the first pan element 6, and a second support element 18, to which the second seat bench region 8 is fixed with its second pan element 12.

Furthermore, the seat device 2 comprises an adjustment mechanism 20, by which at least the second seat bench region 8 can be released without a tool, by moving counter to a joining direction 22 from a first seat position, in which the distance between the first seat bench region 4 and the second seat bench region 8 is minimal and in which the second seat bench region 8 is fixed against moving transversely with respect to the joining direction 22, and can be transferred into an adjustment position, in which the second seat bench region 8 is released for moving transversely with respect to the joining direction 22 and in which the second seat bench region 8, which is moved transversely with respect to the joining direction 22, can be positioned, by moving in the joining direction 22, in at least one second seat position which is offset with respect to the first seat position.

The first seat bench region 4 is fixed lying in contact linearly or extensively on the first support element 16 of the support unit 14 with the first pan element 6.

The second seat bench region 8, in the first seat position and in the second seat position, is fixed in contact linearly or extensively on the second support element 18 of the support unit 14 with the second pan element 12. In the adjustment position, the second pan element 12 of the second seat bench region 8 is arranged without contact with respect to the second support element 18 of the support unit 14.

In the exemplary embodiment shown in the figures, the adjustment mechanism 20 comprises a guide unit 24 by which the moving of the second seat bench region 8 transversely with respect to the joining direction 22 can be guided. For this purpose, in the exemplary embodiment shown in the figures, the guide unit 24 comprises four continuous cutouts 26 in the second pan element 12 and at least one bolt-or pin-shaped guide 28 which extends in the joining direction 22 and is fixed to the support unit 14. The guide 28 has an, in particular complementary, cross section corresponding to the cutout 26. The cutouts 26 are designed in such a way that they form a stop at a first end for the guide 28 level with the first seat position and a stop at a second end for the guide 28 in the second seat position.

Furthermore, in the exemplary embodiments shown in the figures, the adjustment mechanism 20 comprises two protrusions 30, which are arranged on the second pan element 12, and four recesses 32, which are formed in a corresponding, in particular complementary, manner with respect to the protrusions 30 and are arranged on the second support element 18 of the support unit 14.

Each protrusion 30 here is assigned two recesses 32. A first recess 32 is arranged level with the first seat position and a second recess 32 is arranged level with the second seat position. When the protrusion 30 is positioned in one of the recesses 32, a movement of the second pan element 12 transversely with respect to the joining direction 22 is prevented.

In order to fix the second pan element 12 of the second seat bench region 8 in the first seat position and in the second seat position against moving counter to the second joining direction 22, the adjustment mechanism 20 comprises a fixing device 34 by which the second seat bench region 8 is limited at the support unit 14 at least in its movement in or counter to the joining direction 22. Furthermore, the adjustment mechanism 20 comprises a tensioning device 36 with which the second seat bench region 8 is pretensioned in the joining direction 22 onto the support unit 14.

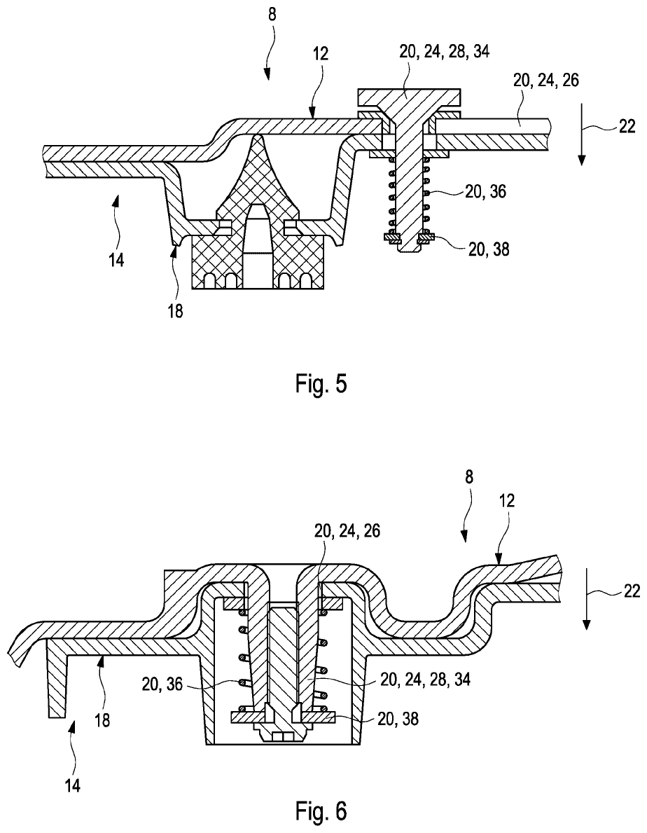

FIG. 5 shows a first exemplary embodiment of the seat device 2, in which the fixing device 34 is designed as a component separable from the second pan element 12. In such a case, the fixing device 34 comprises a head portion with a cross section which is larger than the cross section of the recess 26 in the second pan element 12. A neck portion is arranged adjoining the head portion and extending in the direction of the support unit 14 and also reaching through the tensioning device 36. A stop element 38 is fixed on the side of the fixing device 34 which faces away from the head portion, which stop element comprises an enlarged cross section with respect to the neck portion and on which stop element the tensioning device 36 is supported at one end. The tensioning device 36 is supported on the support unit 14 at the end facing away from the stop element 38. By this means, the second pan element 12 is pretensioned by the head portion of the fixing device 34 in the direction of the support unit 14 by means of the prevailing tensioning force of the tensioning device 36.

When the second pan element 12 is transferred from the seat position into the adjustment position, in such a case it has to be counteracted counter to the tensioning force of the tensioning device 36 in order to be able to space apart the second pan element 12 from the support unit 14 and move the pan element within the cutout 26.

In such a case, the fixing device 34 and the guide 28 form a common integral component.

FIG. 6 shows a second exemplary embodiment of the seat device 2, in which a second pan element 12, guide 28 and fixing device 34 form a common integral component.

A common feature of both exemplary embodiments is that a plurality of buffer elements 40 can be arranged in the support unit 14, in particular in the second support element 18 of the support unit 14, with which forces acting between the second seat bench region 8 and support unit 14 can be cushioned or buffered.

The features of the invention disclosed in the above description, in the claims and in the drawing may be essential both individually and in any desired combination for implementing the invention in its various embodiments.

### LIST OF REFERENCE SIGNS

2 seat device
4 first seat bench region
5 first seat surface
6 first pan element
8 second seat bench region
10 second seat surface
12 second pan element
14 support unit
16 first support element
18 second support element
20 adjustment mechanism
22 joining direction
24 guide unit
26 cutout
28 guide
30 protrusion
32 recess
34 fixing device
36 tensioning device
38 stop element
40 buffer element

1.-10. (canceled)

11. A seat for a tilting vehicle, comprising:
a first seat bench region comprising a first seat surface on which a rider can be positioned for guiding and operating the tilting vehicle, and comprising a first pan element;
a second seat bench region comprising a second seat surface on which a passenger can be positioned, and comprising a second pan element;
a support unit to which the first seat bench region and the second seat bench region are fixable; and
at least one adjustment mechanism by which the second seat bench region is releasable without a tool by moving counter to a joining direction out of a first seat position, in which a distance between the first seat bench region and the second seat bench region is minimal and in which the second seat bench region is fixed against moving transversely with respect to the joining direction, and is transferrable into an adjustment position in which the second seat bench region is released for moving transversely with respect to the joining direction and in which, by moving in the joining direction, the second seat bench region, which is moved transversely with respect to the joining direction, is positionable in a second seat position offset with respect to the first seat position,
wherein in the second seat position the distance between the first seat bench region and second seat bench region is increased with respect to the first seat position, and the second seat bench region is fixed against moving transversely with respect to the joining direction.

12. The seat according to claim 11, wherein
the first seat bench region lies in contact, at least in sections linearly or extensively, on the support unit with the first pan element on a side facing away from the first seat surface, and/or
the second seat bench region, in the first seat position and in the second seat position, lies in contact, at least in sections linearly or extensively, on the support unit with the second pan element on a side facing away from the second seat surface and, in the adjustment position, is spaced apart with the second pan element from the support unit without contact.

13. The seat according to claim 11, wherein
the adjustment mechanism comprises a guide unit by which moving of the second seat bench region transversely with respect to the joining direction is guided,
the guide unit comprises at least one continuous cutout, which extends transversely with respect to the joining direction, in the second pan element and at least one bolt-or pin-shaped guide which extends in the joining direction and is fixed to the support unit and which comprises a cross section corresponding to the cutout.

14. The seat according to claim 13, wherein
the at least one continuous cutout forms a stop at a first end for the guide in the first seat position of the second seat bench region and/or a stop at a second end for the guide in the second seat position of the second seat bench region.

15. The seat according to claim 13, wherein
the adjustment mechanism comprises at least one protrusion on the support unit or on the second pan element, and/or
the adjustment mechanism comprises at least two recesses, which are formed in a corresponding manner with respect to the protrusion, on the second pan element and on the support unit,
one recess is arranged level with the first seat position and another recess is arranged level with the second seat position, and
the protrusion engages in the respective seat position and fixes the second seat bench region against moving transversely with respect to the joining direction.

16. The seat according to claim 15, wherein
the adjustment mechanism comprises at least one fixing device by which the second seat bench region is fixable to the support unit so as to be limited at least in its movement in or counter to the joining direction, and/or
the adjustment mechanism comprises at least one tensioning device by which the second seat bench region is pretensioned in the joining direction onto the support unit.

17. The seat according to claim 16, wherein
the fixing device reaches with a neck portion through the cutout and through an opening in the support unit,
the fixing device comprises a head portion with a cross section which is larger than the cross section of the cutout and which lies on the second pan element in the first seat position and the second seat position, and
at least one stop element is fixable to the fixing device on the neck portion on the side facing away from the head portion and comprises a cross section which is enlarged with respect to the neck portion.

18. The seat according to claim 17, wherein
the tensioning device is supported between the stop element and a side of the support unit facing away from the second pan element, and
the tensioning device is arranged on the fixing device in a manner circumferentially surrounding the neck portion of the fixing device.

19. The seat according to claim 16, wherein
the second pan element, the at least one fixing device, and/or the at least one guide comprise components which are separable from one another.

20. The seat according to claim 16, wherein
the second pan element, the at least one fixing device, and/or the at least one guide comprise components which form a common integral component.

21. The seat according to claim 11, wherein
the support unit comprises an integral common component to which the first seat bench region and the second seat bench region are fixed, or
the support unit comprises a first support element, to which the first seat bench region is fixed, and a second support element, to which the second seat bench region is fixed, wherein the first support element and second support element are fixed releasably or non-releasably to each other.

22. The seat according to claim 11, wherein
the adjustment mechanism comprises at least one protrusion on the support unit or on the second pan element, and/or
the adjustment mechanism comprises at least two recesses, which are formed in a corresponding manner with respect to the protrusion, on the second pan element and on the support unit,
one recess is arranged level with the first seat position and another recess is arranged level with the second seat position, and
the protrusion engages in the respective seat position and fixes the second seat bench region against moving transversely with respect to the joining direction.

23. The seat according to claim 11, wherein
the adjustment mechanism comprises at least one fixing device by which the second seat bench region is fixable to the support unit so as to be limited at least in its movement in or counter to the joining direction, and/or
the adjustment mechanism comprises at least one tensioning device by which the second seat bench region is pretensioned in the joining direction onto the support unit.
